(19) United States
(12) Patent Application Publication
(10) Pub. No.: US 2020/0251089 A1
(43) Pub. Date: Aug. 6, 2020

(54) CONTEXTUALLY GENERATED COMPUTER SPEECH

(71) Applicant: Electronic Arts Inc., Redwood City, CA (US)

(72) Inventor: Jervis Pinto, Foster City, CA (US)

(21) Appl. No.: 16/268,179

(22) Filed: Feb. 5, 2019

(51) Int. Cl. G10L 13/08; G10L 13/047

(52) U.S. Cl. CPC G10L 13/08; G10L 13/047

(57) ABSTRACT

Systems and methods are disclosed herein for using machine learning to automatically modify unstructured scripts with speech tags for a context in which the speech is to be spoken so that the speech can be synthesized to sound more realistic and more contextually appropriate. The systems and methods can be dynamically applied. Training context tags and corresponding structured training scripts are used to train the machine learning system to generate an AI model. The AI model can be used in different ways, and a feedback system is described.

### FIELD

This disclosure relates to computer speech, speech synthesis, and video games.

### BACKGROUND

Computer systems can read text aloud through speakers, but the result is often a monotonic, robotic, and/or unrealistic sounding voice that does not sound as though spoken by a natural person. Also, computer systems may be programmed to read a text line aloud by synthesizing sounds in a particular way to mimic human emotion. However, text spoken by a computer will sound unnatural and lack speaking adjustments that a human would make.

Computer generated voices are presently unrealistic in a wide variety of situations. Instead, to have realistic and appropriately sounding voices, voice actors record lines for playback in movies and in video games. The voice actors can adjust their reading of lines to sound natural and realistic in different contexts that may occur in the movies or video games, even if the voice actors repeat the same words.

### SUMMARY

Some aspects feature a method for automatically adjusting speech of video game characters comprising: receiving a speech script including a sequence of words to be spoken in a video game; generating one or more context tags based on a game state of the video game in which the sequence of words will be spoken; processing the speech script and the one or more context tags with an artificial intelligence (“AI”) speech markup model, wherein the artificial intelligence speech markup model is trained with inputs including at least a plurality of marked speech scripts and a plurality of context tags that respectively correspond to the plurality of marked speech scripts; using the AI speech markup model to generate a structured version of the speech script that includes at least one markup tag added to the speech script, the marking tag indicating at least one speech attribute variation; and synthesizing an audio output of the structured version of the speech script, wherein the audio output is adjusted according to the markup tag added to the speech script.

The method can include one, all, or any combination of the following features. The method can include receiving user input that adds, deletes, or modifies at least one markup tag in the structured version of the speech script; and adjusting the AI speech markup model using the received user input as feedback. The method can include displaying respective context tags for a plurality of speech scripts to one or more users; and receiving, from the one or more users, the plurality of marked speech scripts. The method can include receiving the plurality of context tags from user inputs or generating the plurality of context tags by parsing video game code. The artificial intelligence speech markup model is generated using an AI training system comprising at least one of: a supervised machine learning system; a semi-supervised machine learning system; and an unsupervised machine learning system. The method of claim 1, wherein the artificial intelligence speech markup model includes at least one of: a supervised machine learning model element; a semi-supervised machine learning model element; and an unsupervised machine learning model element. The method further includes dynamically generating, during video game runtime, the one or more context tags in a video game based on a video game state in which the speech script is configured to be read. The method of claim 1, wherein the context tags include at least two of: a video game title or series; a speaker attribute; a video game mode; a video game level; a location in the video game; and an event that occurred in the video game.

Some aspects feature a computer-readable storage device comprising instructions that, when executed by one or more processors, causes a computer system to: access a speech script including a sequence of words to be spoken; obtain one or more context tags describing a virtual context in which the sequence of words will be spoken; process the speech script and the one or more context tags using an artificial intelligence (“AI”) speech markup model, wherein the artificial intelligence speech markup model is trained with inputs including at least a plurality of marked speech scripts and a plurality of context tags that respectively correspond to the plurality of marked speech scripts; use the AI speech markup model to generate a structured version of the speech script that includes at least one markup tag added to the speech script, the marking tag indicating a speech attribute variation; and synthesize an audio recording of the structured version of the speech script, wherein the audio recording is adjusted according to the markup tag added to the speech script.

The storage device can include one, all, or any combination of the following features. The instructions are further configured to cause the computer system to: receive user input that adds, deletes, or modifies at least one markup tag in the structured version of the speech script; and adjust the AI speech markup model using the received user input as feedback. The instructions are further configured to cause the computer system to: display respective contexts a plurality of speech scripts to one or more users; and receive, from the one or more users, the plurality of marked speech scripts. The instructions are further configured to cause the computer system to: receive the plurality of context tags from user inputs or generating the plurality of context tags by parsing video game code. The artificial intelligence speech markup model is generated using an AI training system comprising at least one of: a supervised machine learning system; a semi-supervised machine learning system; and an unsupervised machine learning system. The artificial intelligence speech markup model includes at least one of: a supervised machine learning model element; a semi-supervised machine learning model element; and an unsupervised machine learning model element. The instructions are further configured to cause the computer system to: dynamically generating the one or more context tags in a video game based on a video game state that indicates a context in which the speech script is configured to be read. The context tags include at least two of: a video game title or series; a speaker attribute; a video game mode; a video game level; a location in the video game; and an event that occurred in the video game.

Some aspects feature a computer-implemented method for automatically adjusting speech of video characters comprising: obtaining a speech script including a sequence of words to be spoken; obtaining an artificial intelligence (“AI”) speech markup model that is configured to add speech modifying markup tags to the speech script, wherein the artificial intelligence speech markup model is generated based at least in part on with inputs including a plurality of structured training scripts and a plurality of context tags that respectively correspond to the plurality of structured training scripts; generating one or more context tags based at least in part on a virtual context in which the sequence of words from the speech script will be spoken; generating a structured speech script including a markup tag at a location in the speech script using the AI speech markup model, the speech script, and the one or more context tags; and generating audio output for a video character based on synthesizing the structured speech script, wherein synthesis using the tag makes the video character's speech sound more contextually appropriate.

The computer-implemented method can include one, some, or any combination of the following features. The method further includes receiving user input that adds, deletes, or modifies at least one markup tag in the structured speech script; and adjusting the AI speech markup model using the received user input as feedback. The method further includes dynamically generating the speech script and the one or more context tags during execution of a video game. The method further includes generating the one or more context tags based on a video game state or based on parsing video game code.

The present technology overcomes many of the deficiencies of earlier technology and obtains its objectives by providing an integrated method embodied in computer software for use with a computer for the rapid, efficient contextual script marking and manipulation of character voice expressions, thereby allowing for rapid, creative, and expressive voice products to be produced in a very cost effective manner.

Accordingly, one of the benefits of the technology disclosed herein is to provide a method for automatically producing contextually accurate and realistic sounding speech and vocal variations for virtual characters.

### BRIEF DESCRIPTION OF THE DRAWINGS

FIG. 1A shows an example block diagram of a system for using artificial intelligence to generate contextually structured speech scripts.

FIG. 1B shows another example block diagram of a system for using artificial intelligence to generate contextually structured speech scripts.

FIG. 1C shows yet another example block diagram of a system for using artificial intelligence to generate contextually structured speech scripts.

FIG. 2 shows an example block diagram for generating a trained artificial intelligence model.

FIG. 3 shows an example block diagram for using the trained artificial intelligence model to generate a structured speech script.

FIG. 4 shows an example of using the trained artificial intelligence model to generate a structured speech script.

FIG. 5A shows an example block diagram of a method for using artificial intelligence to generate an AI speech markup model.

FIG. 5B shows an example block diagram of a process for using artificial intelligence to generate a structured speech script with optional revisions and feedback

FIG. 6A shows an example block diagram for using structured speech scripts.

FIG. 6B shows an example block diagram for using structured speech scripts.

FIG. 6C shows an example block diagram for dynamically using structured speech scripts.

FIG. 7 shows an example system for synthesizing speech based on a structured speech script.

FIG. 8 illustrates an embodiment of a hardware configuration for a computing system.

### DETAILED DESCRIPTION

### Introduction

Speech scripts are often written to be spoken, such as lines in a movie, a script for a play, lines in a video game, and the like. Whether in movies, plays, video games, or other similar virtual settings, characters should speak the lines in a contextually appropriate and realistic way. A person may inherently know how to appropriately adjust the manner of speaking the words in different contexts, even if the same words are spoken. People can adjust speech attributes such as speed, pitch, tone, volume, frequency, duration, and the like based on the context. For example, a voice actor may warmly say, “AIright, let's dance,” when accepting a partner's suggestion after a romantic dinner. However, the same voice actor would adjust the speech attributes for dramatic effect to quickly and coldly say, “AIright, let's dance,” after staring down an adversary before accepting a challenge to a physical confrontation.

Computers can use text-to-speech synthesizer systems to read speech scripts aloud. Unlike humans, computers are not inherently aware of contexts. A computer, when presented with certain words to read, would read those words aloud in the exact same way regardless of context. Accordingly, computer spoken lines may sound robotic, monotonic, contextually inappropriate, and/or unrealistic.

In some cases, speech scripts can be structured with a markup language, such as Speech Synthesis Markup Language (“SSML”), to provide more realistic and more contextually appropriate sounding speech. Parts of a speech script can be structured with speech tags to indicate variations in speech attributes. However, to add SSML tags, an author is required to manually edit a speech script by adding SSML tags for every speech variation. This can be a laborious and time consuming task. In many cases where lines are pre-scripted, manually adding SSML tags is so tedious that computer synthesized voices are not used. Instead, voice actors quickly read the scripted lines to provide natural sounding audio. Although SSML tags can be manually added by people while drafting, producing, or otherwise preparing an artistic work, manually added SSML tags are unsuitable for computer speech that is dynamically generated on the fly as real time responses to user interactions.

Systems and methods are disclosed herein for using artificial intelligence (“AI”) systems to allow computer systems to quickly, accurately, and automatically markup speech scripts with speech tags based on a context that words are spoken in. In video game applications, the context can include data about a game state. When read with the added markup language, computer synthesized speech can sound more contextually appropriate and realistic. Using the systems and methods can save substantial amounts of labor, whether in the form of voice acting or coding SSML tags. For example, computers can synthesize and/or record more realistic and contextually appropriate speech for use in videos, video games, and the like. Furthermore, the system can be automated such that contextually generated speech tags can be dynamically generated fast enough to be applied by computers in real time interactions with users. For example, an AI model can be included in a video game to make dynamically generated speech sound more contextually appropriate and realistic, or a computer configured to vocally respond to user interactions dynamically generate speech that sounds more contextually appropriate and realistic.

### Example Systems

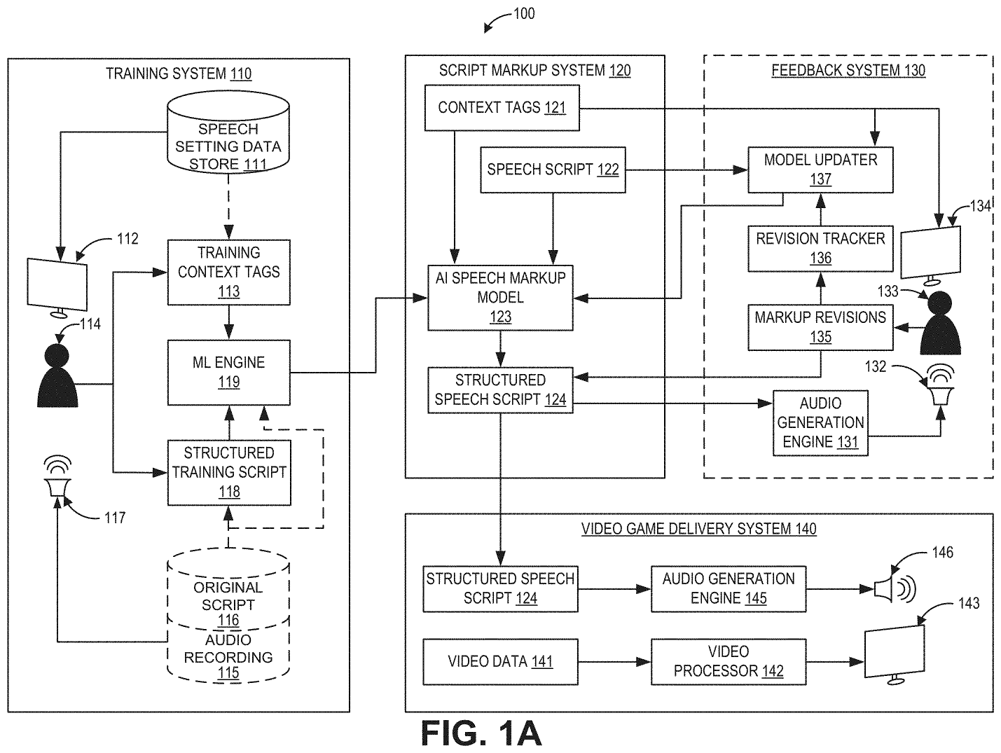

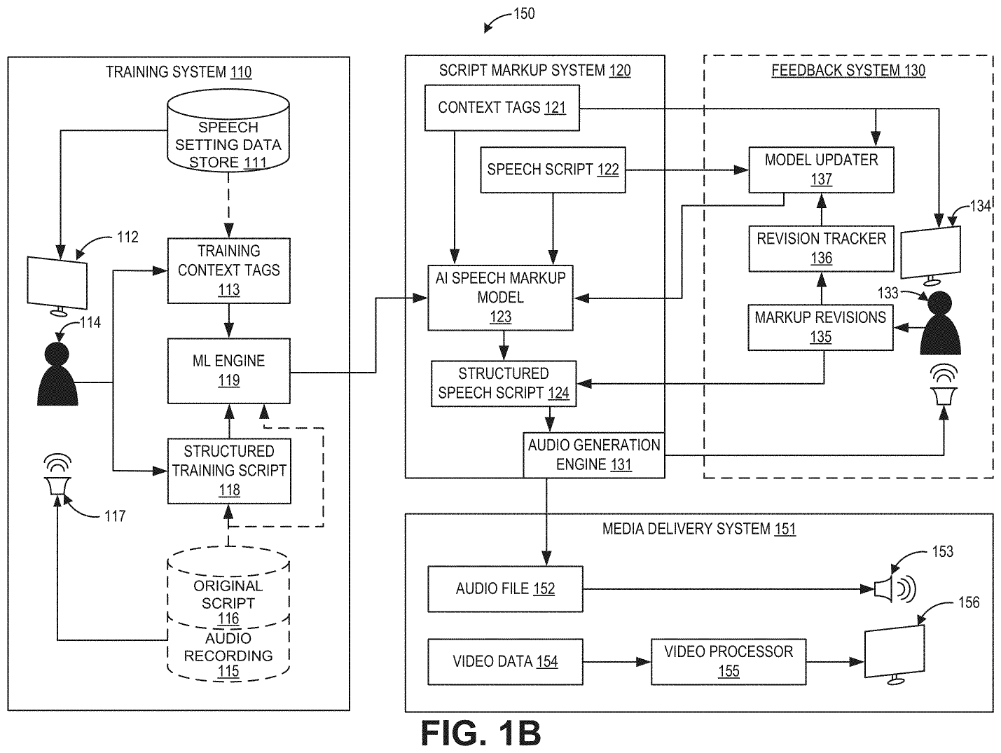

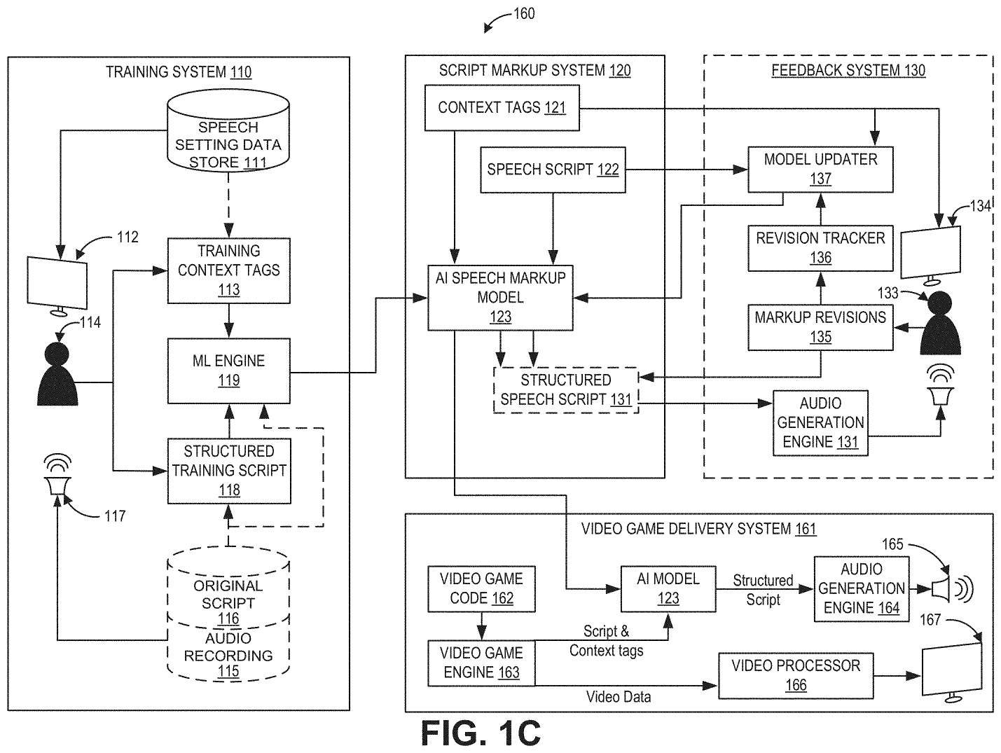

FIG. 1A shows an example block diagram of a system 100 for using artificial intelligence to generate contextually structured speech scripts. The system 100 includes a training system 100, a script markup system 120, an optional feedback system 130, and a video game delivery system 140. The training system 110 includes a speech setting data store 111, a video output device 112, training context tags 113, audio recordings 115 and corresponding original scripts 116, an audio output device 117, structured training scripts 118 that are marked up versions of the original scripts 116, and a machine learning engine 119. The script markup system 120 includes an AI speech markup model 123 generated by the machine learning engine 119, context tags 121 for a video or video game, a speech script 122, and a structured version of the speech script 124. The feedback system includes an audio generation engine 131, an audio output device 132, a video output device 134, markup revisions 135, and a model updater 136. The video game delivery system 140 includes a copy of the structured speech script 124, an audio generation engine 145, a speaker 146, video or video game data 141, a video or video game processor 142, and a video output device 143. One or more users 114, 133 may interact with the systems as illustrated.

The training system 110 is configured to use a machine learning engine 119 to generate an AI speech markup model 123. One or more users 114 can provide training data to the machine learning engine 119 including a structured training script 118 and one or more training context tags 113 for each respective structured training script 118.

A video or video game data store 111 can include data about instances of speech spoken in different contextual settings. Example data sources can include movies, screenplays, video games, books, and the like. One or more users 114 can review the contexts that included the speech. For example, the users 114 can view a scene from a movie, read a scene from a screenplay, read a scene from a book, watch or play a scene in a video game, read source code for executing the scenes of the video game, and the like.

For each context including speech, the users 114 can generate training context tags 113. Training context tags 113 can be used to train a machine learning system about how to adjust speech attributes for each context. Training context tags 113 can include, for example, attributes about a speaker, such as the speaker's name, gender, age, location, place of origin, race, species, or any other attribute. For example, in a video game, a speaker may be a male elf from planet Elf World, so context tags such as “gender=male,” “species=elf,” and “origin=Elf World” can be provided when the elf is speaking. Training context tags 113 can also include environmental situational descriptions, such as a title of the work or series in which the speech occurs, a location in which the speech occurs, a mood during which the speech occurs, and the like. The training context tags 113 can also include information from a game state, such as events that occurred before the speech occurs, timings of the events relative to the speech, a level or mode in a video game, and the like. Events in video games can include talking to certain characters, completing mission objectives, fighting, equipping items, using items, obtaining items, reaching checkpoints, using skills, making storyline decisions, trading with other players, making in-game transactions, and the like.

In some embodiments, where text or source code is digitally available in the speech setting data store 111, some or all of the training context tags 113 can be generated by parsing the digital text or source code. For example, the text or source code can be parsed to search for keywords indicative of setting contexts, such as searching for proper noun names to generate speaker identifier tags, the words “he” or “she” to generate speaker genders tags, and the like. Video game source code can be parsed to generate setting tags for levels, locations, the object properties, names of object instances, and the like. Accordingly, in some embodiments, computer generation of the training context tags 113 can be optionally, alternatively, or additionally used in place of receiving training context tags 113 from users 114.

For respective speech that occurs in the respective settings, respective structured training scripts 118 are received from the one or more users 114. The structured training scripts 118 can be marked with speech tags such as SSML tags to indicate customizations in pronunciation based on the respective context. Speech tags other than SSML can also be used, and the speech tags can include any form of description identifying a modification or customization about how a script should be synthesized. Examples include speech tags that describe prosody, volume, speed, frequency, duration, emotions, background effects, a voice of a person or group of users, and the like. Some higher level speech tags can be parsed to cause a plurality of secondary speech tags to be applied to a script. For example, a speech tag such as <angry> </angry> can cause <volume=“+5”> and <speed=“7”> to be initially applied, and <volume=“+7”> to be applied halfway through the <angry> </angry> tag. Different synthesizers can parse the higher level speech tags in different ways. The higher level speech tags can also be parsed differently for different speakers. Speech tags can be applied to modify any speech attribute.

In some embodiments, the speech tags can include new tags beyond the tags presently available in SSML. For example, the new tags can include <whisper>, <angry>, <fear>, <confrontational>, <robotic>, <tough guy>, <heavy>, <progressively_slower>, <creepy> and other types of speech tags. In some embodiments, new tags can be automatically created by the machine learning engine or speech markup model.

Examples of receiving structured training scripts 118 includes receiving, from the one or more users 114, user input marking up existing versions of the structured training scripts 118 or user input providing both the structured training scripts 118 and the markup. For example, the one or more users 114 can watch a scene from a video game or movie, provide the training context tags 113, and also provide a transcript of the speech that was spoken including training tags describing how the speech was varied for the particular context. If an original version of the script 116 is available, such as from the source code for the video game or from a screenplay of the movie, then the users 114 can generate the structured training scripts 118 by adding, modifying, or deleting at least one markup tag from the original scripts 116.

As another example, audio recordings 115 can be played through a speaker 117 for the users 114 to hear. If the original scripts 116 are available for the corresponding audio recordings 115, then the users 114 can provide markup tags describing how the speech was varied during the context of the played audio recording 115. The markup tags can be applied to the original scripts 116 to form the structured training scripts 118. The users can also transcribe the audio recordings 115 if the corresponding original scripts 116 are unavailable.

In some embodiments, the audio recordings 115 can be separate from the speech setting data store 111. For example, a first group of users or a computer program may analyze the speech setting data store 111 to generate training context tags 113, while a second group of users listen to respectively associated audio recordings 115 and markup a script with speech tags 118 (and provide a transcript if the original script is not available). In some embodiments, the audio recordings 115 and the speech setting data 111 are combined, such as in a movie or video game. One or separate groups of users 114 can watch the setting and listen to the audio at the same time to provide the training context tags 113 and the structured training scripts 118.

In some cases, original scripts 116 may be available. For example, the source code for a video game, a screenplay for a movie, or a digital version of a book may include editable scripts of the speech spoken in the video game, movie, or book. When the original scripts 116 are available, users can augment the original scripts with markup tags describing how the speech was varied for the particular context without transcribing the speech. In some embodiments where audio 115 is available but original scripts 116 are not, the original scripts can be generated using speech-to-text systems.

In some cases, the original scripts 116 may include a limited amount of markup. For example, a video game source code can include a script and a speaker identity so that a particular voice will be used to synthesize the script. Users 114 can mark up the original script 116 by adding, modifying, or deleting at least one speech tag of the original scripts 116 to generate the structured training scripts 118.

The machine learning engine 119 is configured to receive at least a plurality of training context tags 113 and respective structured training scripts 118 as inputs. In some embodiments, the machine learning engine 119 is also configured to receive the original script 116 as an input so that the machine learning engine 119 can more quickly learn and more accurately model the markups made to scripts. The machine learning engine 119 can be any type of machine learning system, incorporating elements of supervised machine learning systems, semi-supervised machine learning systems, and unsupervised machine learning systems. Examples of supervised machine learning systems can include neural network machine learning systems such as feedforward neural networks, convolutional neural networks, and recurrent neural networks. Supervised classification algorithms such as logistic regression, support vector machines, and linear classification can additionally or alternatively be used. Semi-supervised machine learning systems can include structured prediction systems, data augmentation or label induction, few-shot learning, or nearest neighbor classification systems. Unsupervised machine learning systems can be employed through the use of natural language processing for learning vector representations of text. Elements of these systems can use TF-IDF representations, matrix factorization methods such as singular value decomposition or prediction-based methods such as word2vec. The machine learning engine 119 is configured to learn how markups are applied to speech in various contexts by training using the inputs. After training, the machine learning engine can generate an AI speech markup model 123.

The AI speech markup model 123 is configured to receive context tags 121 and a speech script 122 and generate a structured version of the speech script 124 that includes markup generated based at least on the context tags 121. The markup customizes the speech scripts to adjust the prosody, volume, speed, frequency, duration, emotions, background effects, a voice of a person or group of people, and the like to be appropriate and more realistic for various contexts. Accordingly, the AI speech markup model 123 can be used so that computer synthesized speech will sound appropriately different in different contexts. The AI speech markup model 123 can be any type of model. Some example models can include supervised machine learning, semi-supervised machine learning and unsupervised machine learning model elements. Choices of supervised model elements can include neural network machine learning model elements such as feedforward neural network elements, convolutional neural network model elements or recurrent neural network model elements. Supervised classification model elements such as logistic regression elements, support vector model elements or linear classification model elements can additionally or alternatively be used. Semi-supervised machine learning model elements can include structured prediction models elements, data augmentation or label induction models elements, few-shot learning models elements, or nearest neighbor classification models elements. Unsupervised machine learning model elements can be generated by the use of natural language processing for learning vector representations of text. These model elements can include TF-IDF model elements, matrix factorization model elements such as singular value decomposition model elements, or prediction-based model elements such as word2vec.

An optional feedback system 130 can be used to improve the quality of the structured speech transcript 124 and the AI speech markup model 123. The structured speech script 124 can be provided to and processed with an audio generation engine 131 that synthesizes or otherwise generates data for an audio speaking of the structured speech script 124. The audio data can be provided to an audio output device 132, such as a speaker.

One or more users 133 (who may be the same as or different from the one or more users 114) can listen to the audio output from the speaker 132 to judge whether the speech sounds contextually appropriate and realistic. The one or more users 133 can also review the context of the speech through a video output device 134. The review can occur, for example, by watching a scene where the structured speech script 124 occurs, looking at the context tags 121 describing the setting in which the structured speech script 124 occurs, reading source code where the structured speech script 124 occurs, observing an original setting (e.g., in a book, from a movie, from a screenplay) where the structured speech script 124 occurs, and the like.

The one or more users can provide markup revisions 135 that change the markup tags in the structured speech script 124 generated by the AI speech markup model 123. Few or no manual revisions may be required after a well-trained and well-generated AI speech markup model 123 has received sufficient training and/or feedback. When markup revisions 135 are received, the markup revisions 135 can be applied to the structured speech script 124.

A revision tracker 136 can be used to track any changes made to the structured speech script 124. A model updater 137 can be configured to update the AI speech model 123 with feedback based on the revisions 135. If no markup revisions are made to the structured speech script 124, then positive reinforcement feedback can be provided to the AI speech markup model 123. If markup revisions 135 are made to the speech script 124, then the context tags 121, speech script 122, and the revised structured speech script can be used as inputs to re-train the machine learning system and update the AI speech markup model 123.

In the example shown in FIG. 1A, a copy of the structured speech script 124 (with optional revisions) is provided as a component in a video game delivery system 140. For example, the copy of the structured speech script 124 can be embodied as data in a non-transitory, computer readable medium. An audio generation engine 145 is configured to synthesize the structured speech script 124 as audio, adjusting the speech based on the markup tags. Example audio generation engines can include processors or sound cards configured to generate or synthesize scripts using text-to-speech or other technology.

Video data 141 can also be provided as a component in the video game delivery system 140. The video data (or instructions for generating the video data) can also be embodied in the same or different non-transitory, computer readable medium. The video data 141 can be rendered by a video processor 142, such as a graphics processing unit or general processing unit, for display through a video output device 143 such as a television, monitor, smartphone, laptop, screen, or the like. Accordingly, the speech generated from the speakers 146 can sound more contextually appropriate and realistic for the video context shown in the video output device 143.

FIG. 1B shows an example block diagram 150 of a system for using artificial intelligence to generate contextually structured speech scripts. The identically numbered components of FIG. 1B are the same as the corresponding components described with respect to FIG. 1A. FIG. 1B includes a media delivery system 151 instead of the video game delivery system 140 from FIG. 1A. The media delivery system 151 includes an audio file 152, an audio output device 153, video data 154, a video processor 155, and a video output device 156.

The audio file 152 can be generated by the audio generation engine 131. The audio file 152 can be synthesized or otherwise generated by the audio generation engine 131 based on the structured speech script 124. During synthesis or generation, the markup tags in the structured speech script cause the audio file to be modified to sound more contextually appropriate and realistic for the corresponding context in the video data 154.

After synthesis, the audio file 152 and the corresponding video data 154 can be stored on a same or different non-transitory, computer readable medium, such as a CD, DVD, memory card, hard drive, video game disk, and the like. The audio file can be played through the audio output device 153 while the corresponding video data 154 is rendered by a video processor 155 and displayed through a video output device 156. The audio file 152 can include speech that is synchronized with the video data 154,

FIG. 1C shows an example block diagram of a system 160 for using artificial intelligence to generate contextually structured speech scripts. The identically numbered components of FIG. 1C are the same as the corresponding components described with respect to FIG. 1A. FIG. 1C includes a different embodiment of a video game delivery system 161. The video game delivery system 161 includes video game code 162, a video game engine 163, an AI model 123, an audio generation engine 164, an audio output device 165, a video processor 166, and a video output device 167. In the video game delivery system 161, scripts can be dynamically generated, structured based on context, synthesized, and output in real time. Although the example in FIG. 1C is described with respect to a video game, the technology disclosed can be used in other contexts outside of video games, such as for generating contextually realistic sounding computer speech for user interfacing, for reading text on screens, and the like.

Video game code 162 and a copy of the AI speech model 123 can be embodied on the same or different non-transitory, computer readable mediums. The video game code 162 may also be referred to as a videogame, a game, game code, and/or a game program. The video game code 110 should be understood to include software code that a computing system 102 can use to provide a game for a user to play. A game application 110 may comprise software code that informs a computing system of processor instructions to execute, but may also include data used in the playing of the game, such as data relating to constants, images, other data structures, rules, prerecorded motion capture poses/paths, environmental settings, constraints, skeleton models, route information, game state information, and/or other game application information. In some embodiments, one or more computing systems can execute the video game code, which may be stored and/or executed in a distributed environment. For example, a first computing system may execute a portion of a game, and a network-based computing system may execute another portion of the game.

The video game engine 163 can be configured to execute aspects of the operation of the video game code 162. Execution of aspects of gameplay within a game application can be based, at least in part, on the user input received from input devices and the video game code 163. The video game engine 163 can execute gameplay within the game according to the game rules. Examples of game rules can include rules for scoring, possible inputs, actions/events, movement in response to inputs, and the like. Other components can control what inputs are accepted and how the game progresses, and other aspects of gameplay. The video game engine 163 can receive the inputs from an input device and determine in-game events, such as actions, jumps, runs, throws, attacks, and other events appropriate for a video game application.

During runtime, the video game engine 163 can dynamically generate a virtual world and cause virtual events in the virtual world to dynamically occur. For example, in a video game, characters can dynamically interact with other characters and with virtual environments, players can play different game modes or different levels, the video game's storyline can progress, and the like. Dynamic events, such as characters moving, interacting with virtual objects, fighting, shooting, obtaining items, completing quests or objectives, scoring, and other events can occur in the video game.

Video data can be generated by the video game engine 163. The video game can be rendered by a video processor 166 and displayed through a video output device 167 so that a player can see what is occurring in the video game. The video data can continuously update as events occur in the video game.

Events in the video game may include virtual characters speaking. The scripts can be pre-scripted (such as during cut scenes) or dynamically generated. Dynamically generated scripts may be generated or assembled in response to user interactions and events that occurred in the game. Indeed, languages provide infinite or near-infinite possibilities of combinations of words. In some cases, the quantity of possible scripts that can be dynamically generated is too great to pre-process or prerecord because recording would take too long and the resulting sound files would take impractically large amounts of storage space.

A script can be dynamically generated based at least in part on events that occur in the video game and/or player inputs. The video game engine 163 can generate context tags describing the setting or game state in which the script will be spoken. For example, the video game engine 163 can provide context tags such as the name of the character who will speak the script, the gender of the character who will speak the script, the place of origin of the character who will speak the script, the age of the character who will speak the script, the species of the character who will speak the script, and other character attributes. The video game engine 163 can also generate context tags describing the video game title, the level, the game mode, recent events that occurred in the video game, and the like.

The script and the context tags can be provided to the AI model 123, which can be a copy of the AI speech markup model. The AI model can, in real time, receive the script and the context tags as inputs and generate a structured audio script. The structured audio script can include markup tags customizing the script based on the context tags to make the resulting audio sound more contextually appropriate and realistic.

For example, if a script (such as “Let's go”) is to be spoken and the video game engine provides certain tags indicative of stealth operations (such as video game titles related to espionage, a context tag indicated that a player is armed with a weapon including a silencer, that a video game character is prone or in shadow, and the like), then the script can be structured with speech tags indicating lower volumes, slower speaking, and a frequency change to sound whispery. If the script (such as “Let's go”) is to be spoken and the video game engine provides certain context tags indicative of action (such as a sports related video game title, during a fight, other character dialog is marked with increased volume, characters are using loud or unsilenced weapons), then the script can be structured with speech tags to indicate louder volumes, faster speaking, and frequency changes to sound excited.

The structured speech script can be provided to an audio generation engine 164 to synthesize or generate audio for output through the audio output device 165, such as speakers. During synthesis or generation, the markup tags in the structured speech script 124 cause the audio file to be modified to sound more contextually appropriate and realistic for the corresponding context in the video shown on the video output device 167 (e.g., to sound whispery during a stealth operations or to sound excited during action).

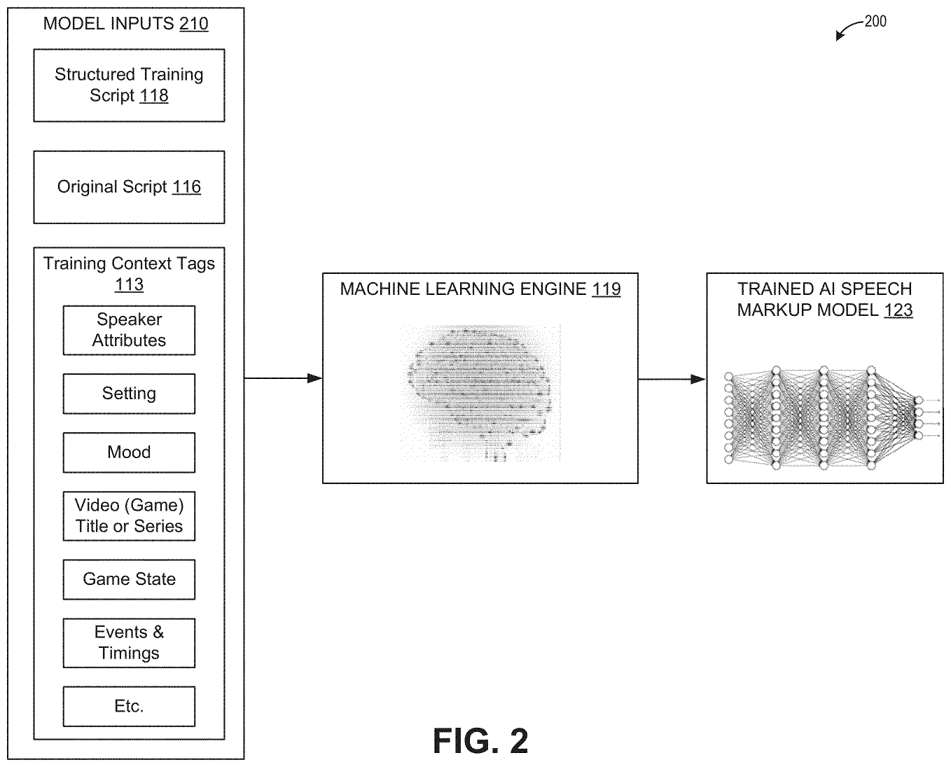

FIG. 2 shows an example block diagram 200 for generating a trained artificial intelligence model. The block diagram includes model inputs 210, a machine learning engine 119, and a trained AI speech markup model 123. The model inputs can include a structured training script 118, an original script 116, and training context tags 113.

The machine learning engine 119 is configured to receive the model inputs 210 for training and to generate a trained AI speech markup model 123. The machine learning engine 119 can be any type of machine learning system, incorporating elements of supervised machine learning systems, semi-supervised machine learning systems, and unsupervised machine learning systems. Examples of supervised machine learning systems can include neural network machine learning systems such as feedforward neural networks, convolutional neural networks, and recurrent neural networks. Supervised classification algorithms such as logistic regression, support vector machines, and linear classification can additionally or alternatively be used. Semi-supervised machine learning systems can include structured prediction systems, data augmentation or label induction, few-shot learning, or nearest neighbor classification systems. Unsupervised machine learning systems can be employed through the use of natural language processing for learning vector representations of text. Elements of these systems can use TF-IDF representations, matrix factorization methods such as singular value decomposition or prediction-based methods such as word2vec.

The model inputs 210 can include a plurality of sets of training data. A first set of training data can include a first original script 116, a first structured training script 118 that includes the words of the first original script 116 and also includes speech tags such as SSML tags that are added to, deleted from, or changed from the first original script 116, and at least one first training context tag 113 describing a context in which the original script 116 is spoken. Examples of the training context tags 113 can include, for example, attributes about a speaker, such as the speaker's name, gender, age, location, place of origin, race, species, or any other attribute. Training context tags 113 can also include environmental situational descriptions, such as a title of the work or series in which the speech occurs, a location in which the speech occurs, a mood during which the speech occurs, and the like. The training context tags 113 can also include information from a game state, such as events that occurred before the speech occurs, timings of the events relative to the speech, a level or mode in a video game, and the like. A second set of training data can include a second original script 116, a second structured training script 118 corresponding to the second original script 116, and a second context tag describing a context in which second original script 116 is spoken. In some embodiments, the original scripts 116 can be omitted, and the model inputs 210 can include the structured training scripts 118 and the training context tags. If the original scripts 116 are included, then the structured training script 118 can be compared to the original script 116 to more quickly determine which markup tags should be added, deleted, or modified. In some embodiments, if the original script 116 is not provided, then all markup tags in the structured training script 118 can be treated as having been added based on the training context 113. Data for the model inputs 210 can be obtained, for example, from existing libraries of movies, video games, plays, and the like. The data for the model inputs 210 can additionally or alternatively be creatively generated by people.

In some embodiments, large numbers of training sets can be used as the model inputs 210. The model inputs 210 can include hundreds, thousands, or millions of training sets, or more. The machine learning engine 119 can be implemented by a computer system including one or more processors, and the processors can use the model inputs 210 to train the machine learning engine 119 in practical amounts of time. Even when thousands, millions, or even greater numbers of training sets are provided, the processors can train the machine learning engine in days, hours, or minutes, or seconds depending on the quantity of training sets and the available computing power. In any case, the computer system can process the model inputs 210 at speeds and quantities that are impossible for a person to similarly perform.

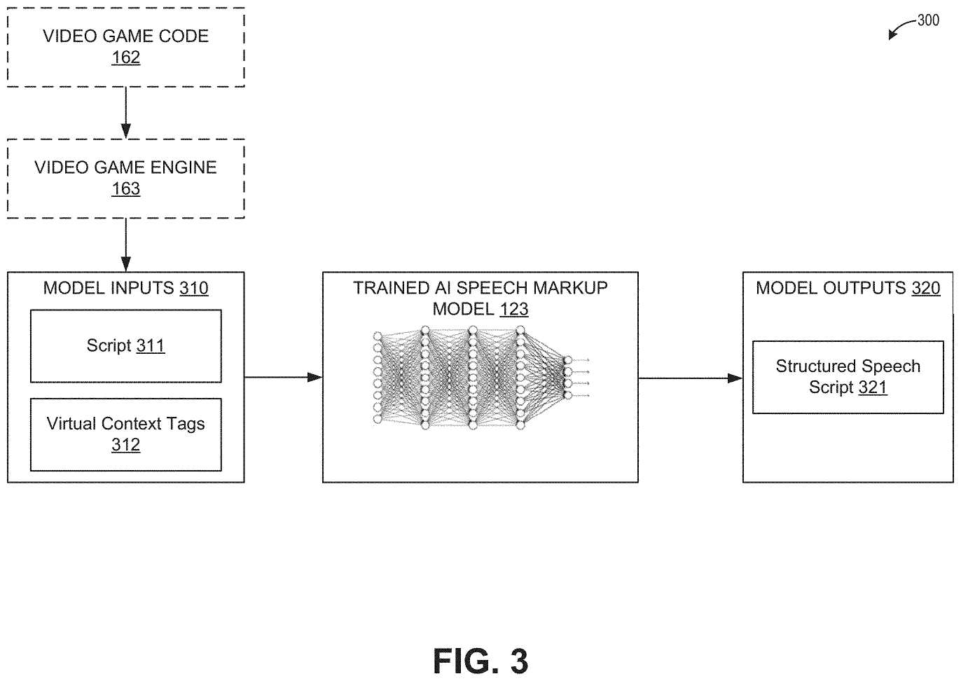

The machine learning engine 119 is configured to train using the model inputs 210 to generate a trained AI speech markup model 123. The AI speech markup model 123 can be any type of model. Some example models can include supervised machine learning, semi-supervised machine learning and unsupervised machine learning model elements. Choices of supervised model elements can include neural network machine learning model elements such as feedforward neural network elements, convolutional neural network model elements or recurrent neural network model elements. Supervised classification model elements such as logistic regression elements, support vector model elements or linear classification model elements can additionally or alternatively be used. Semi-supervised machine learning model elements can include structured prediction models elements, data augmentation or label induction models elements, few-shot learning models elements, or nearest neighbor classification models elements. Unsupervised machine learning model elements can be generated by the use of natural language processing for learning vector representations of text. These model elements can include TF-IDF model elements, matrix factorization model elements such as singular value decomposition model elements, or prediction-based model elements such as word2vec. Once generated based on the training sets, the trained AI speech model 123 can be used to receive new context tags, receive a new original script, and generate a structured version of the new original script based at least in part on the new context tags. The structured version of the new original script includes one or more tags indicating customizations in pronunciation based on the respective context. An example is further discussed with respect to FIG. 3.

FIG. 3 shows an example block diagram 300 for using the trained artificial intelligence model to generate a structured speech script 321. The system includes video game code 162, a video game engine 163, model inputs 310 including a script 311 and one or more context tags 312, a trained AI speech markup model 123, and model outputs 320 that include a structured speech script 321. In FIG. 3, the trained AI speech markup model 123 is used to generate a structured speech script 321 based at least in part on a script 311 and one or more context tags 312. The trained AI speech markup model can be trained as described in FIG. 2.

In FIG. 3, the model inputs 310 include a script 311 that is provided to the trained AI speech markup model 123 so that the trained AI speech markup model 123 can modify the script 311 by adding, deleting, or modifying speech tags. In some embodiments, the model inputs 310 can be dynamically generated by a video game engine 163 based on video game code 162.

In some embodiments, the model inputs 310 can be generated during a development process, such as during the development of a movie or during the development of a video game. The script 311 can be written and provided, and context tags 312 of the movie or video game can be written and provided. The model inputs can be used by the trained AI speech markup model 123 to generate a structured speech script 321. A computer system can then synthesize the structured speech script 321, such as by using a text to speech program, speaking the script 321 with variations in speech attributes based on speech tags added by the trained AI speech markup model 123. In some embodiments, the spoken audio can be recorded and saved as an audio file for playback and can be optionally included with a corresponding video. In some embodiments, the structured speech script 321 can be saved as text and synthesized at runtime.

In some other embodiments, the model inputs 310 can be all or partially dynamically generated during execution of a game or playback of a video scene. For example, a video game can include video game code 162 configured to be executed by one or more processors. A video game engine 163 can be configured to execute aspects of the operation of the video game code 162. Execution of aspects of gameplay within a game application can be based, at least in part, on the user input received from input devices and the video game code 163. During runtime, the video game engine 163 can dynamically generate the script 311 and/or the context tags 312 based on the video game state. In some cases, the script can be prewritten into a storyline. For example, a video game may always end with, “Good job—we saved the world, and no we can go home!” as the last dialog line in a video game's story. In some cases, scripts can be dynamically generated based on events that happen in a game. For example, an announcer may be configured to generate dynamic announcements such as, “Pass from [athlete_name_1] across the court to [custom_character_name]. [custom_character_name] pulls a move. He shoots, he scores!” in real time in response to a player in sports game causing a pass from an athlete character to the custom named character, and then shooting with the custom character to successfully score a point.

In the sports game example, the video game engine 163 can execute the video game code 162 to cause the sport game to run on a computer system with one or more characters acting in response to one or more player's inputs and with an opposing team of characters responding accordingly. The video game engine 163 can generate the context tags 312 based on the virtual setting, speaker attributes, events in the video game, and/or other game state information. The virtual setting can include, for example, a sports arena, the type of sport being played, a fictional planet, and the like. The speaker attributes can include, for example, the announcer's name, the announcer's species (such as a ghost, a person, an elf, an orc, a robot, or other fictional creature), the announcer's age, and the like. Events in the game can include whether the game is close, which team has possession or a turn, whether a player is leading or behind, whether the other team recently scored, and the like. The game state can also include a title of the video game, time remaining in the sport, a game mode, a level, and the like.

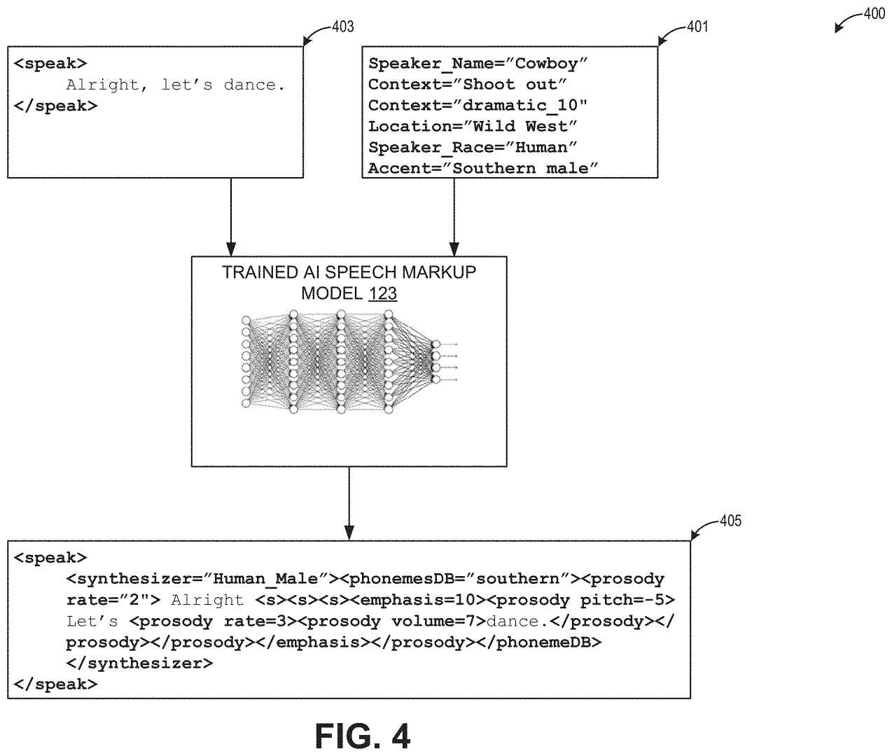

Based on how training sets of data have structured training scripts in view of similar context tags, the trained AI speech model 123 can similarly mark up the script 311 with speech tags to generate a structured speech script 321. An example is provided in FIG. 4.

FIG. 4 shows an example 400 of using the trained artificial intelligence model to generate a structured speech script 405. An example of context tags 401 and an original script 403 are provided to a trained AI speech markup model 123, which generates a structured speech script 405 as an output.

The original script 403 can be read in a number of different ways in different contexts. While a person may naturally know how to adjust speech attributes for a particular context, a computer faces a technological challenge because computer processors lack such innate decision making processes. Computers are instead capable of performing math and logic, but there is no standard math equation for how to adjust the reading of “AIright, let's dance,” in view of the many different contexts where it could be spoken.

The trained AI speech markup model 123 is configured to mark up the speech script 403 based on the provided context tags 401. The trained AI speech markup model 123 generates the example structured speech script 405 that includes a plurality of speech tags. The generated tags can include tags for sound effects, tags for using a speaker synthesizer for a particular character, and prosody tags specifying emphasis, pitch, and rate.

In an example embodiment, the speech tags can be suggested and displayed to users during development. For example, a programmer may be working on writing the line 403 in the context of the video game. The context of the video game may indicate, for example, that a particular person is programmed to speak the line, “AIright, let's dance.” This context can be parsed and provided to the trained AI speech markup model that can suggest real time tags as a programmer is typing the line or when a programmer completes portions of a speech, such as a sentence. The tags may appear as suggestions that the programmer can accept or reject. In some embodiments, the speech tags shown in 405 may appear as predictive tags or dropdown options while the programmer is typing in an interface.

### Example Flowcharts

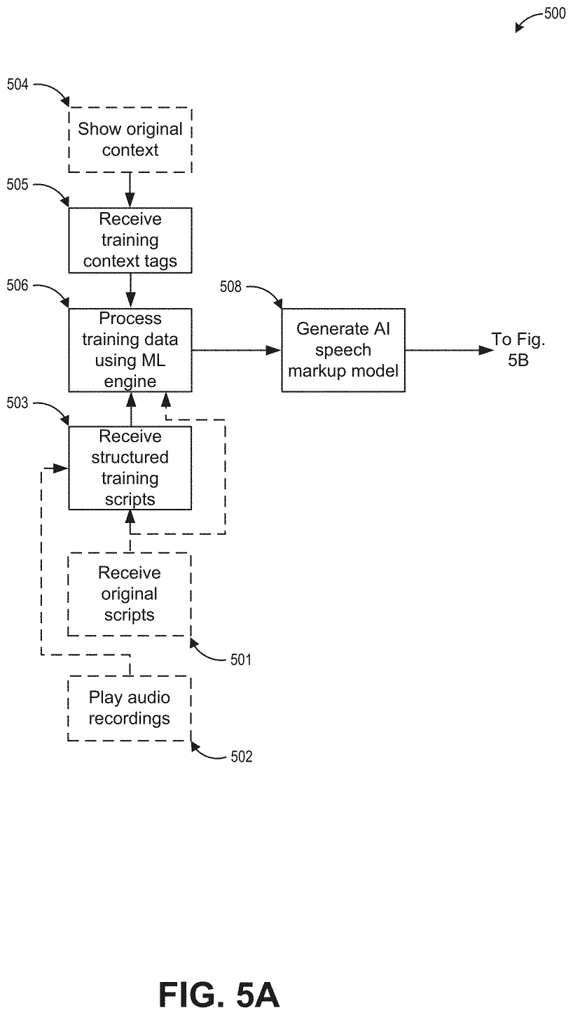

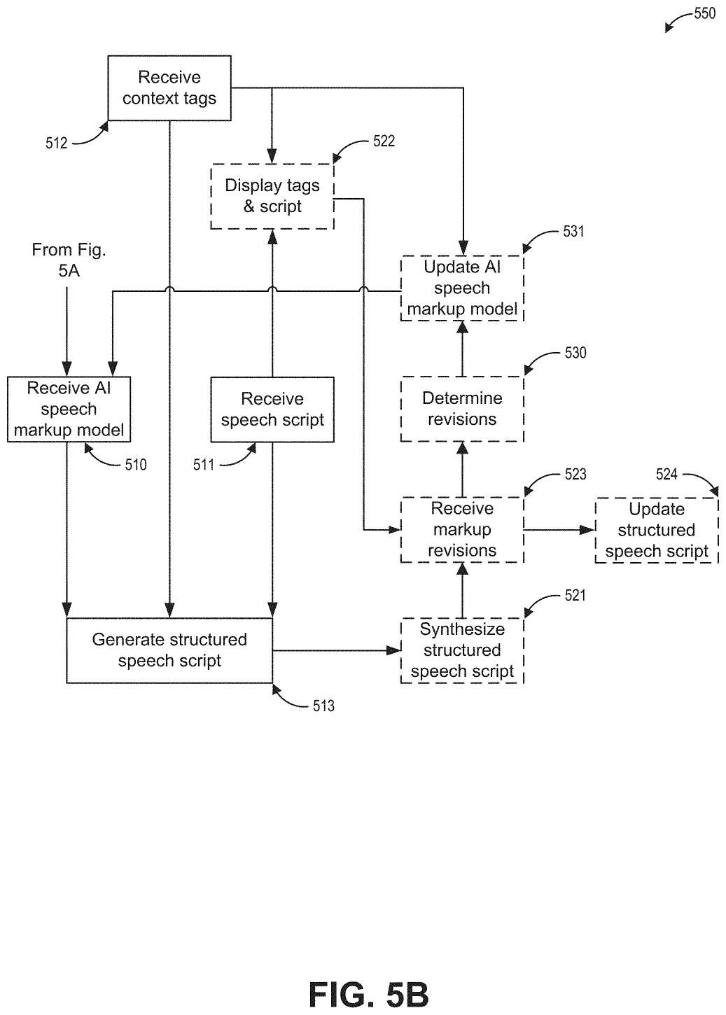

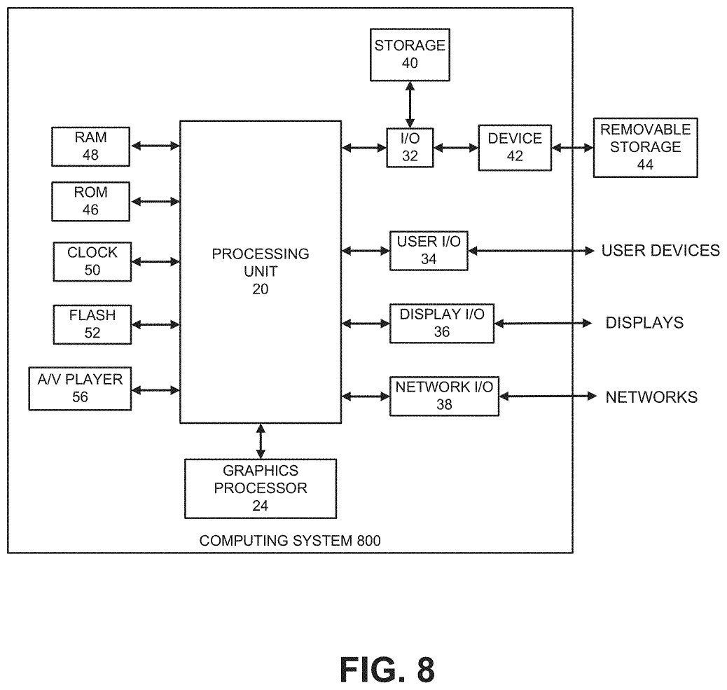

FIG. 5A shows an example block diagram 500 of a process for using artificial intelligence to generate an AI speech markup model. The process 500 can be implemented by any computer system, such as the computer system 800 described with respect to FIG. 8. Users, such as the users 114 of FIG. 1A, FIG. 1B, and/or FIG. 1C, can provide one or more of the inputs to the process 500. Advantageously, embodiments of the process 500 can be used to generate AI speech markup models that can be used as subsequently described with respect to FIG. 5B. Although any number of systems, in whole or in part, can implement the process 500, to simplify discussion, the process 500 will be described with respect to particular systems. [0073] At block 501, original scripts can be received or accessed. The original scripts can be used for training a machine learning engine.

At block 502, audio recordings of the original speech scripts can be optionally played, synthesized, and/or transmitted for playback/synthesis.

At block 503, structured training scripts can be received. The structured training scripts can include at least one speech tag that indicates one or more variations in speech attributes for a corresponding context. The structured training script can be a version of the original script that is marked up with speech tags that are provided by one or more users.

At block 504, the corresponding context of the original script or structured training script can be shown or transmitted for display. This allows for one or more users to see the context of the original script or structured training script so that they can provide training context tags.

At block 505, training context tags can be received. The training context tags can describe the setting or video game state in which the original script occurred.

At block 506, the respective original scripts, respective structured training scripts, and respective training context tags can be provided as sets of training data to a machine learning engine to be processed. In some embodiments, the original scripts can be omitted. The machine learning engine is configured to generate a model that marks up scripts with speech tags based on context tags.

At block 508, an AI speech markup model is generated as an output of the machine learning engine. The AI speech markup model is configured to mark up new scripts based on corresponding context tags provided for the new scripts. Accordingly, the AI speech markup model is configured to mark up new scripts with speech tags similarly to how the original scripts were marked up in similar contexts. Block 508 can proceed to block 510 described with respect to FIG. 5B.

FIG. 5B shows an example block diagram 550 of a process for using artificial intelligence to generate a structured speech script with optional revisions and feedback. The process 550 can be implemented by any computer system, such as the computer system 800 described with respect to FIG. 8. The process 550 can be performed by the same or different systems used for performing the process 500. Users, such as the users 133 of FIG. 1A, FIG. 1B, and/or FIG. 1C, can provide one or more of the inputs to the process 550, and the users can be the same as or different from the users providing inputs to the process 500. Advantageously, embodiments of the process 550 can use AI speech markup models generated in FIG. 5A to generate structured speech scripts and update the AI speech markup models with feedback. Although any number of systems, in whole or in part, can implement the process 550, to simplify discussion, the process 550 will be described with respect to particular systems.

At block 510, an AI speech markup model can be received or accessed. The AI speech markup model can be generated as described with respect to block 508 of FIG. 5A.

At block 511, a speech script can be received. In some embodiments, the speech script can be dynamically generated during execution of a video game. In some embodiments, the speech script can be generated during development.

At block 512, one or more context tags can be received. In some embodiments, the one or more context tags can be dynamically generated during execution of a video game. The one or more context tags can describe and be generated based on a game state of the video game or based on a virtual context of a video in which the speech script is to be spoken. In some embodiments, the context tags can be during development.

At block 513, a structured speech script can be generated using the AI speech markup model from block 510 based on the one or more context tags from block 512 and the speech script from block 511. The structured speech script can include speech tags indicating one or more variations in speech attributes such that when the speech script is synthesized, the resulting audio will sound more realistic and/or more contextually appropriate. In some embodiments, the structured speech script of block 513 can be a second, updated version of the speech script from block 511.

At block 521, the structured speech script can be synthesized or transmitted for synthesis and playback. The synthesis can include an adjustment to at least one speech attribute based on the speech tags. One or more users can listen to the synthesized structured speech script to determine if revisions to the speech tags are appropriate.

At block 522, the context tags and/or speech script can be displayed or transmitted for display. One or more users can listen to the synthesized speech script while reviewing the context and/or original speech script. The users may provide feedback in the form of markup revisions that change the speech tags in the structured speech script.

At block 523, one or more markup revisions to the structured speech script can be received. The revisions can add speech tags to, delete speech tags from, or modify the speech tags in the structured speech script.

At block 524, the structured speech script can be updated with the one or more markup revisions. Accordingly, the updated structured speech script can be a third, updated version of the speech script from block 511.

At block 530, the revisions can be determined or tracked. For example, a diff tool, input logger, or revision tracker can be used.

At block 531, the revisions from block 530 or block 523, the corresponding context tags from block 512, and/or the speech script from block 511 can provided as feedback data to the machine learning model, and the AI speech markup model can be updated based at least in part on the feedback data. Accordingly, the AI speech markup model is configured to mark up subsequent scripts with speech tags based at least in part on the feedback data and on how the original scripts were marked up in similar contexts.

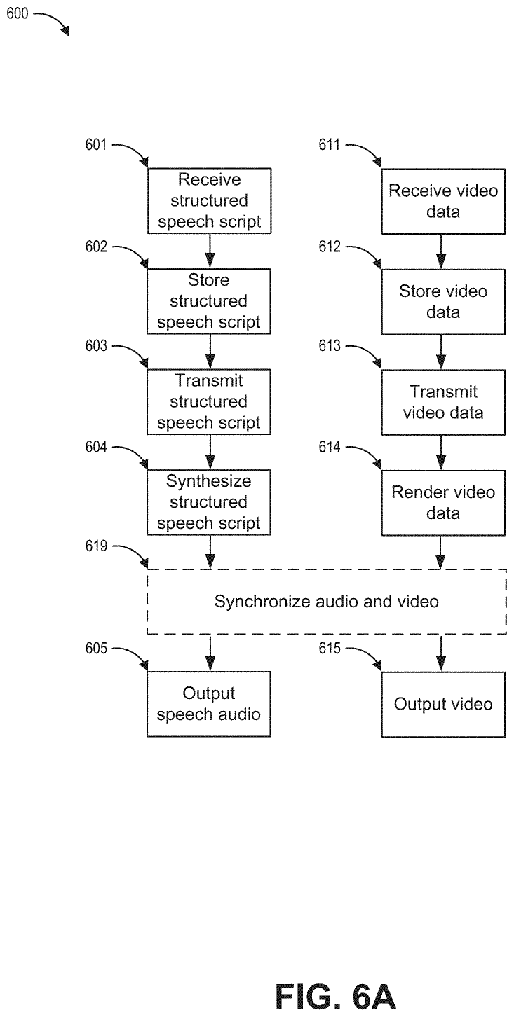

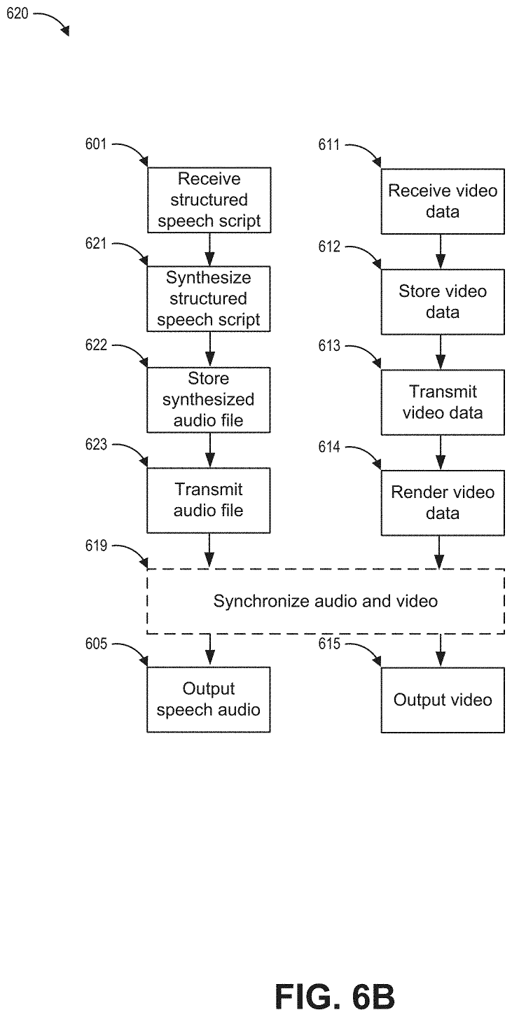

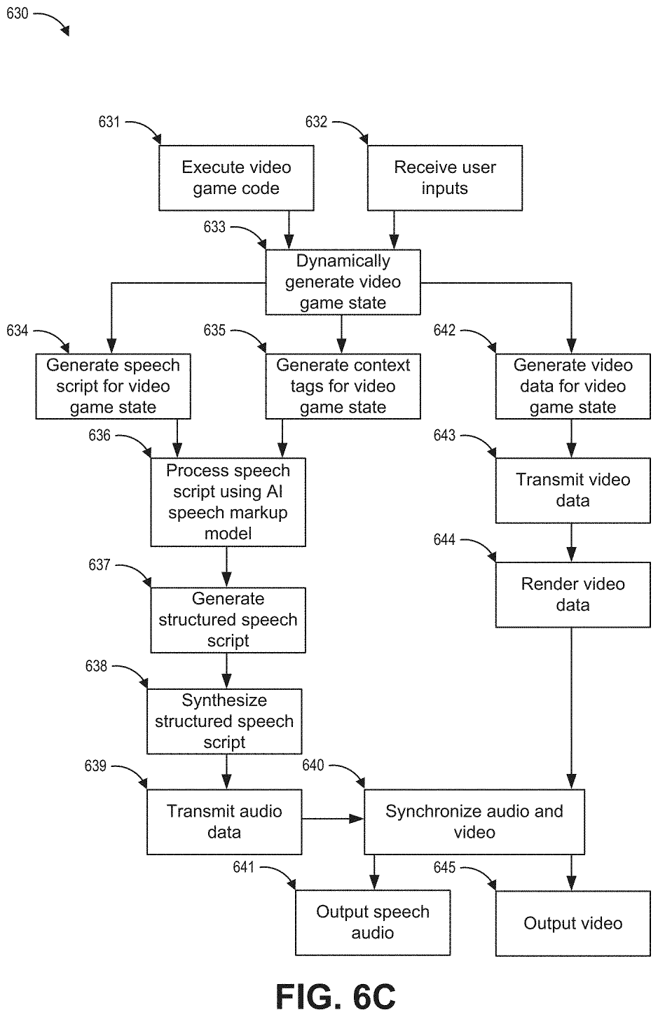

FIG. 6A shows an example block diagram 600 for using structured speech scripts. In some embodiments, blocks 601-605 can be performed synchronously or substantially in sync with block 611-615, such as for presenting a video or video game. In some embodiments, blocks 601-605 can be performed without blocks 611-615, such as for presenting speech audio for radio transmission or other audio presentation without video.

At block 601, a structured speech script can be received. The structured speech script can be generated and optionally updated as described in FIG. 5B.

At block 602, the structured speech script can be stored on a non-transitory, computer-readable medium. For example, the speech script can be stored on a hard drive, read-only media (ROM), digital video disc (DVD), database, server, or flash drive as part of a video or video game.

At block 603, the structured speech script can be transmitted to a speech synthesizer. For example, the structured speech script can be transmitted to a general purpose processor or audio processor to synthesize the structured transcript. In some examples, the speech script can be stored in a database on a first computer system (such as a server) transmitted to a processor on the first computer system or over a network to a processor on a second computer system (such as a client) for synthesis.

At block 604, the structured speech script can be synthesized. For example, the structured speech script can be synthesized using text to speech technology. The synthesized audio can include an adjustment to at least one speech attribute based on the speech tags in the structured speech script. In some alternative embodiments, the structured speech script can be synthesized on a first computer system (such as a server) at block 604 and the resulting synthesized audio data can be transmitted at block 603 to a second computer system (such as a client).

At block 605, the structured speech script can be output as speech audio, such as through speakers. In some embodiments, the speech audio can be synchronized with video that is output at block 615.

At block 611, video data can be received. The video data can be used for generating video to be displayed synchronously with the audio, such as in a video or video game.

At block 612, the video data can be stored. In some embodiments, the video data can be stored on the same or different device as the audio data.

At block 613, the video data can be transmitted, such as to a general purpose processor or video processor. In some examples, the video data can be stored in a database on a first computer system (such as a server) and transmitted to a processor on the first computer system or over a network to a processor on a second computer system (such as a client) for display.

At block 614, the video data can be rendered. In some alternative embodiments, the video can be rendered by a first computer system in block 614 and the rendered video can be transmitted in block 613.

At block 615, the rendered video can be output for display, such as through a screen, monitor, or projector.

In some embodiments, after blocks 604 and 614, the audio and video can be optionally synchronized at block 619 before the speech audio is output at block 605 synchronously with the video output at block 615. Synchronizing can include buffering either the video and/or audio until both are ready. Although the example embodiment illustrates synchronization at block 619 after block 604 and block 614, other embodiments can additionally or alternatively include synchronizing at other times.

FIG. 6B shows an example block diagram 620 for using structured speech scripts. The example embodiment shown in block diagram 620 is a variation of the example embodiment shown in block diagram 600. Blocks 601, 605, and 611-615 of FIG. 6B are the same as or similar to the correspondingly numbered blocks of FIG. 6A.

At block 621, the structured speech script can be synthesized into an audio file.

At block 622, the synthesized audio file can be stored on a non-transitory, computer-readable medium. The audio file can be stored on the same non-transitory, computer-readable medium as the video data.

At block 623, the synthesized audio file can be transmitted for playback.

In some embodiments, after blocks 623 and 614, the audio and video can be optionally synchronized at block 619 before the speech audio is output at block 605 synchronously with the video output at block 615. Synchronizing can include buffering either the video and/or audio until both are ready. Although the example embodiment illustrates synchronization at block 619 after block 623 and block 614, other embodiments can additionally or alternatively include synchronizing at other times.

FIG. 6C shows an example block diagram 630 for dynamically using structured speech scripts. In video games, speech can be dynamically synthesized to sound more realistic and more contextually appropriate.

At block 631, video game code can be executed. The code can be executed, for example, by a computer, by a gaming console, by a smartphone, by a server, and the like.

At block 632, user inputs can be received. The user inputs can control virtual actions within the video game. User inputs can be received, for example, through a keyboard, mouse, touchpad, game controller, joystick, microphone, and the like.

At block 633, a video game state is dynamically generated based at least in part on the user inputs and the execution of the video game.

At block 634, a speech script can be generated for the video game state. The speech script can be predetermined and/or dynamically generated in response to events that occurred in the video game.

At block 635, context tags for the speech script can be generated based on the video game state. The context tags can include speaker attributes for the speaker who will speak the script, the virtual setting, game state, and/or events in the video game.

At block 636, the speech script can be processed using the AI speech markup model that was previously described herein. The AI speech markup model is configured to add, delete, or modify the speech script with speech tags to make synthesized speech sound more realistic and contextually appropriate.

At block 637, a structured speech script can be generated as an output of the AI speech markup model.

At block 638, the structured speech script can be synthesized to generate audio data. The speech script is synthesized to generate audio data that includes at least one speech attribute variation that makes the audio sound more realistic and contextually appropriate.

At block 639, the audio data can be transmitted, such as to an audio processor or speaker.

At block 640, the audio data from block 639 be synchronized with video data from block 644.

At block 641, the audio data can be output as speech audio, such as through a speaker. In some embodiments, the speech audio is output synchronously with the output video in block 644.

At block 642, video data can be generated for the video game state.

At block 643, the video data can be transmitted, such as to a processor in a same or different computer system.

At block 644, the video data can be rendered to generate a video output.

At block 645, the rendered video can be output through a display device.

Variations of the flowchart shown in FIG. 6C can include performing different blocks in the same (e.g., locally using a gaming console) or different computer systems (e.g., in online server-client implementations), with data being adapted for transmission for the appropriate configuration.

### Example Speech Synthesis System

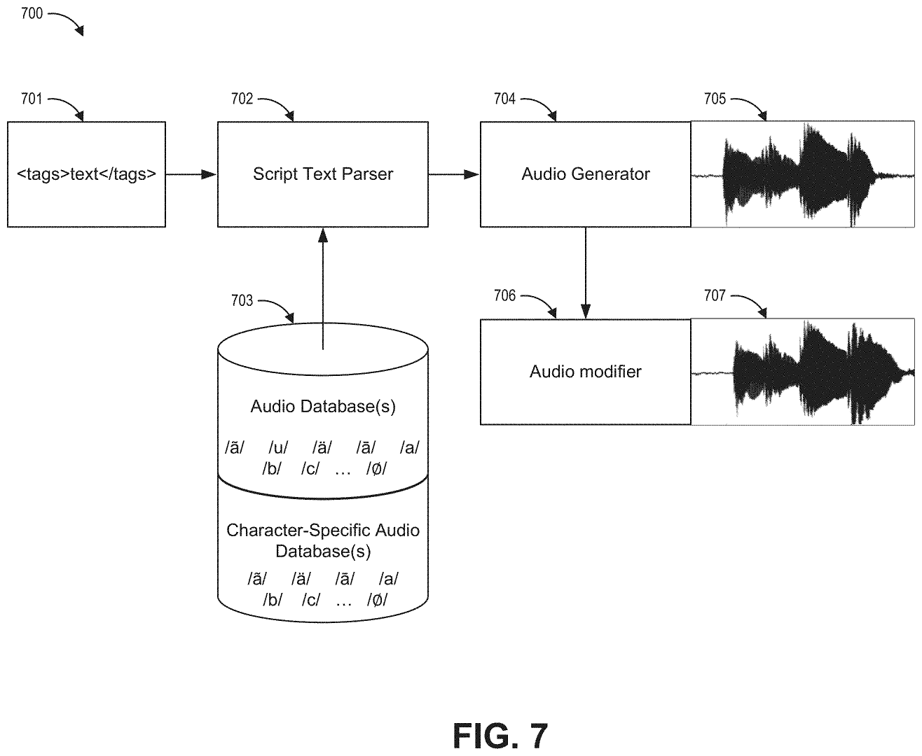

FIG. 7 shows an example system 700 for synthesizing speech based on a structured speech script. The system includes a structured speech script 701, a script text parser 702, one or more audio databases 703, an audio generator 704, an initial audio file 705, an audio modifier 706, and a second audio file 707.

A structured speech script 701 is processed by the script text parser 702. The script text parser is configured to parse the text in the structured speech script 701 into phonemes or parts for which audio is available. An audio database of phonemes 703 can be searched to find the appropriate phoneme or audio. The audio database 703 may include different audio variations for different speakers, speakers with different accents, speaking with different emotions, and other speech attributes. In some embodiments, the audio databases 703 can include different sets of phonemes for different speakers or characters. For example, a first set of phonemes can be used for a first character in a video game series, and a second set of phonemes can be used for a second character. The audio database 703 may not have a sample for every possible variation or combinations of speech attributes. For example, the audio database may not include samples of audio spoken at every volume, with every speed adjustment, and the like.

An audio generator 704 combines the available phonemes as audio 705 for the structured text.

An audio modifier 706 can further modify parts of the audio 705 based on any speech tags in the structured speech script 701 for which specific audio is unavailable in the audio database 703. For example, the volume adjustments, speech adjustments, and the like can be applied by the audio modifier. The audio modifier can apply each adjustment as indicated by the tags in the structured speech script 701.

### Example Hardware Configuration of Computing System

FIG. 8 illustrates an embodiment of a hardware configuration for a computing system 800. The computing system can be used to implement the example training systems 110, script markup system 120, feedback system 130, video game delivery system 140, media delivery system 151, and/or video game delivery system 161 as shown in FIGS. 1A-1C.

Other variations of the computing system 800 may be substituted for the examples explicitly presented herein, such as removing or adding components to the computing system 800. The computing system 800 may include a computer, a server, a smart phone, a tablet, a personal computer, a desktop, a laptop, a smart television, and the like.

As shown, the computing system 800 includes a processing unit 20 that interacts with other components of the computing system 800 and also components external to the computing system 800. A game media reader 22 may be included that can communicate with game media. Game media reader 22 may be an optical disc reader capable of reading optical discs, such as CD-ROM or DVDs, or any other type of reader that can receive and read data from game media. In some embodiments, the game media reader 22 may be optional or omitted. For example, game content or applications may be accessed over a network via the network I/O 38 rendering the game media reader 22 and/or the game media optional.

The computing system 800 may include a separate graphics processor 24. In some cases, the graphics processor 24 may be built into the processing unit 20, such as with an APU. In some such cases, the graphics processor 24 may share Random Access Memory (RAM) with the processing unit 20. Alternatively, or in addition, the computing system 800 may include a discrete graphics processor 24 that is separate from the processing unit 20. In some such cases, the graphics processor 24 may have separate RAM from the processing unit 20. Further, in some cases, the graphics processor 24 may work in conjunction with one or more additional graphics processors and/or with an embedded or non-discrete graphics processing unit, which may be embedded into a motherboard and which is sometimes referred to as an on-board graphics chip or device.

The computing system 800 also includes various components for enabling input/output, such as an I/O 32, a user interface I/O 34, a display I/O 36, and a network I/O 38. As previously described, the input/output components may, in some cases, including touch-enabled devices. The I/O 32 interacts with storage element 40 and, through a device 42, removable storage media 44 in order to provide storage for the computing system 800. The storage element 40 can store a database that includes the failure signatures, clusters, families, and groups of families. Processing unit 20 can communicate through I/O 32 to store data, such as game state data and any shared data files. In addition to storage 40 and removable storage media 44, the computing system 800 is also shown including ROM (Read-Only Memory) 46 and RAM 48. RAM 48 may be used for data that is accessed frequently, such as when a game is being played, or for all data that is accessed by the processing unit 20 and/or the graphics processor 24.

User I/O 34 is used to send and receive commands between processing unit 20 and user devices, such as game controllers. In some embodiments, the user I/O 34 can include touchscreen inputs. The touchscreen can be a capacitive touchscreen, a resistive touchscreen, or other type of touchscreen technology that is configured to receive user input through tactile inputs from the user. Display I/O 36 provides input/output functions that are used to display images from the game being played. Network I/O 38 is used for input/output functions for a network. Network I/O 38 may be used during execution of a game, such as when a game is being played online or being accessed online.

Display output signals may be produced by the display I/O 36 and can include signals for displaying visual content produced by the computing system 800 on a display device, such as graphics, user interfaces, video, and/or other visual content. The computing system 800 may comprise one or more integrated displays configured to receive display output signals produced by the display I/O 36, which may be output for display to a user. According to some embodiments, display output signals produced by the display I/O 36 may also be output to one or more display devices external to the computing system 800.

The computing system 800 can also include other features that may be used with a game, such as a clock 50, flash memory 52, and other components. An audio/video player 56 might also be used to play a video sequence, such as a movie. It should be understood that other components may be provided in the computing system 800 and that a person skilled in the art will appreciate other variations of the computing system 800.

Program code can be stored in ROM 46, RAM 48, or storage 40 (which might comprise hard disk, other magnetic storage, optical storage, solid state drives, and/or other non-volatile storage, or a combination or variation of these). At least part of the program code can be stored in ROM that is programmable (ROM, PROM, EPROM, EEPROM, and so forth), in storage 40, and/or on removable media such as game media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other game and processor data as needed. RAM is used and holds data that is generated during the play of the game and portions thereof might also be reserved for frame buffers, game state and/or other data needed or usable for interpreting user input and generating game displays. Generally, RAM 48 is volatile storage and data stored within RAM 48 may be lost when the computing system 800 is turned off or loses power.

As computing system 800 reads game media 12 and provides a game, information may be read from game media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as game media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves, increases, or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, and the like, may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A method for automatically adjusting speech of video game characters comprising:
receiving a speech script including a sequence of words to be spoken in a video game;
generating one or more context tags based on a game state of the video game in which the sequence of words will be spoken;
processing the speech script and the one or more context tags with an artificial intelligence (“AI”) speech markup model, wherein the artificial intelligence speech markup model is trained with inputs including at least a plurality of marked speech scripts and a plurality of context tags that respectively correspond to the plurality of marked speech scripts;
using the AI speech markup model to generate a structured version of the speech script that includes at least one markup tag added to the speech script, the marking tag indicating at least one speech attribute variation; and
synthesizing an audio output of the structured version of the speech script, wherein the audio output is adjusted according to the markup tag added to the speech script.

2. The method of claim 1, further comprising:
receiving user input that adds, deletes, or modifies at least one markup tag in the structured version of the speech script; and
adjusting the AI speech markup model using the received user input as feedback.

3. The method of claim 1, further comprising:
displaying respective context tags for a plurality of speech scripts to one or more users; and
receiving, from the one or more users, the plurality of marked speech scripts.

4. The method of claim 1, further comprising:
receiving the plurality of context tags from user inputs or generating the plurality of context tags by parsing video game code.

5. The method of claim 1, wherein the artificial intelligence speech markup model is generated using an AI training system comprising at least one of:
a supervised machine learning system;
a semi-supervised machine learning system; and
an unsupervised machine learning system.

6. The method of claim 1, wherein the artificial intelligence speech markup model includes at least one of:
a supervised machine learning model element;
a semi-supervised machine learning model element; and
an unsupervised machine learning model element.

7. The method of claim 1, further comprising:
dynamically generating, during video game runtime, the one or more context tags in a video game based on a video game state in which the speech script is configured to be read.

8. The method of claim 1, wherein the context tags include at least two of:
a video game title or series;
a speaker attribute;
a video game mode;
a video game level;
a location in the video game; and
an event that occurred in the video game.

9. A computer-readable storage device comprising instructions that, when executed by one or more processors, causes a computer system to:
access a speech script including a sequence of words to be spoken;
obtain one or more context tags describing a virtual context in which the sequence of words will be spoken;
process the speech script and the one or more context tags using an artificial intelligence (“AI”) speech markup model, wherein the artificial intelligence speech markup model is trained with inputs including at least a plurality of marked speech scripts and a plurality of context tags that respectively correspond to the plurality of marked speech scripts;
use the AI speech markup model to generate a structured version of the speech script that includes at least one markup tag added to the speech script, the marking tag indicating a speech attribute variation; and
synthesize an audio recording of the structured version of the speech script, wherein the audio recording is adjusted according to the markup tag added to the speech script.

10. The computer-readable storage device of claim 9, wherein the instructions are further configured to cause the computer system to:
receive user input that adds, deletes, or modifies at least one markup tag in the structured version of the speech script; and
adjust the AI speech markup model using the received user input as feedback.

11. The computer-readable storage device of claim 9, wherein the instructions are further configured to cause the computer system to:
display respective contexts a plurality of speech scripts to one or more users; and
receive, from the one or more users, the plurality of marked speech scripts.

12. The computer-readable storage device of claim 9, wherein the instructions are further configured to cause the computer system to:
receive the plurality of context tags from user inputs or generating the plurality of context tags by parsing video game code.

13. The computer-readable storage device of claim 9, wherein the artificial intelligence speech markup model is generated using an AI training system comprising at least one of:
a supervised machine learning system;
a semi-supervised machine learning system; and
an unsupervised machine learning system.

14. The computer-readable storage device of claim 9, wherein the artificial intelligence speech markup model includes at least one of:
a supervised machine learning model element;
a semi-supervised machine learning model element; and
an unsupervised machine learning model element.

15. The computer-readable storage device of claim 9, wherein the instructions are further configured to cause the computer system to:
dynamically generating the one or more context tags in a video game based on a video game state that indicates a context in which the speech script is configured to be read.

16. The computer-readable storage device of claim 9, wherein the context tags include at least two of:
a video game title or series;
a speaker attribute;
a video game mode;
a video game level;
a location in the video game; and
an event that occurred in the video game.

17. A computer-implemented method for automatically adjusting speech of video characters comprising:
obtaining a speech script including a sequence of words to be spoken;
obtaining an artificial intelligence (“AI”) speech markup model that is configured to add speech modifying markup tags to the speech script, wherein the artificial intelligence speech markup model is generated based at least in part on with inputs including a plurality of structured training scripts and a plurality of context tags that respectively correspond to the plurality of structured training scripts;
generating one or more context tags based at least in part on a virtual context in which the sequence of words from the speech script will be spoken;
generating a structured speech script including a markup tag at a location in the speech script using the AI speech markup model, the speech script, and the one or more context tags; and
generating audio output for a video character based on synthesizing the structured speech script, wherein synthesis using the tag makes the video character's speech sound more contextually appropriate.

18. The method of claim 17, further comprising:
receiving user input that adds, deletes, or modifies at least one markup tag in the structured speech script; and
adjusting the AI speech markup model using the received user input as feedback.

19. The method of claim 17, further comprising:
dynamically generating the speech script and the one or more context tags during execution of a video game.

20. The method of claim 17, further comprising:
generating the one or more context tags based on a video game state or based on parsing video game code.
